(19) United States
(12) Patent Application Publication
(10) Pub. No.: US 2009/0314258 A1
(43) Pub. Date: Dec. 24, 2009

(54) COMBUSTION ENGINE INJECTOR HOLDER RETAINING FORK

(75) Inventor: Yvon Azou, Nogent sur Marne (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/374,667

(22) PCT Filed: Jul. 10, 2007
(86) PCT No.: PCT/FR07/51628

§ 371 Date: Jan. 21, 2009

(30) Foreign Application Priority Data
Jul. 21, 2006 (FR) 0653076

(51) Int. Cl. F02M 61/14

(52) U.S. Cl. 123/470

(57) ABSTRACT

The invention relates to a retaining fork for holding an element such as an injector holder onto a support such as a cylinder head of a combustion engine. The fork (4) has two branches (26, 27) intended to bear against the element by surrounding a head (21) of this element comprising at least one flat (36) to prevent this element from rotating. A shank (23) intended to bear against the support, and a central opening (28) intended to accept a clamping screw (29) engaged in the support. The fork comprises an elastic element (42) with which one of its branches (27) is equipped and which defines two elastic supports (38, 39) interposed between an internal face (41) of this branch and the head (21) of the element so as to keep a flat (36) of this head bearing against an internal face (37) of the opposite branch (26).

The present invention claims priority from French application 0653076, filed Jul. 21, 2006, the contents of which (description, claims, and drawings) are incorporated herein by reference.

The invention relates to a fork for retaining an element on a support, such as a fork for retaining an injector holder on a cylinder head of a heat engine. The invention also relates to a device for attaching an injector holder to a cylinder head of a heat engine comprising a fork of this kind.

An injector holder can be retained on a heat engine cylinder head by a fork-type retaining element that has one end bearing on an upper surface of the injector holder, and another end bearing on a corresponding surface of the cylinder head.

This fork also comprises a central opening in which the clamp screw that is screwed into the cylinder head is engaged. After positioning this fork, inserting and tightening the screw makes it possible to secure the injector holder translationally in its position in the cylinder head.

However, the shape of the injector holder is generally cylindrical, and retaining or attaching the latter with a fork does not make it possible to secure it rotationally with the required precision.

Securing the injector in an appropriate angular position on its rotational axis is nonetheless a determining factor for combustion quality.

That is, an injector of this kind comprises an injection end located in the combustion chamber, from which multiple distinct streams issue with each injection, evenly spaced from one another around the rotational axis of the injector.

Combustion quality requires, among other things, that one of these streams, known as a reference stream, be very close to the end of the engine spark plug.

If the angular position of the injector on its rotational axis is poorly adjusted, the distance between the end of the spark plug and the nearest stream becomes too large. In particular, this defective positioning is a handicap when starting the vehicle cold, and an obstacle to reducing pollution.

In order to improve the angular positioning of the injector, it has been proposed that a fork be used comprising two arms that bear on an upper surface of the injector holder while also extending around a head of this injector body.

The head is provided with two flat areas, so that engaging the fork on the head makes it possible to rotationally immobilize the injector directly when it is mounted.

However, due to the distance between the lower end of the injector and the end of the spark plug, it turns out that a slight difference in the angular position of the injector with respect to a reference position results in too large a gap between the spark plug and the nearest stream.

The purpose of the invention is to propose a retaining or attachment fork for an injector holder that makes it possible to ensure a precise angular position of this injector when it is mounted.

To this end, an object of the invention is a fork for retaining an element on a support, such as a fork for retaining an injector holder on a cylinder head of a heat engine, this fork comprising an extension intended to bear on the support and provided with a central opening intended to accept an element for clamping to the support, and two arms intended to bear on the element by extending around a head of this element, comprising at least one flat area to secure this element rotationally. According to the invention, the fork has an elastic element provided on one of its arms, which defines two elastic bearings interposed between an inner face of this arm and the head of the element so as to keep a flat area of this head pressed against an inner face of the opposite arm.

Introducing an elastic element between a fork arm and one of the two flat areas of the injector holder makes it possible to counter the forces resulting from tightening the screw that attaches the fork to the support, helping to keep the symmetry axis of the flat area of the injector holder aligned with respect to the axis of the fork attachment screw.

In a preferred alternative embodiment, the central opening additionally comprises a seat with an axisymmetric shape, ensuring that the fork is centered with respect to a head of the clamping element when this clamp screw is tightened.

The invention also relates to a fork as defined above, in which the element for clamping to the support is a screw.

The invention also relates to a fork as defined above, in which the seat has a spherical cap shape so as to define a ball-joint-type connection with the head of the clamping element.

The invention also relates to a fork as defined above, comprising an elastic element provided on one of its arms, which defines two elastic bearings interposed between an inner face of this arm and the head of the element so as to keep a flat area of this head pressed against an inner face of the opposite arm.

The invention also relates to a fork as defined above, in which the elastic element comprises two elastic bearings spaced apart from one another along the inner face of the arm so as to bear on a flat area of the head of the element.

The invention also relates to a fork as defined above, in which the elastic element comprises a metal plate, and in which the elastic bearing points are bulged portions of this metal plate.

The invention also relates to a fork as defined above, in which the elastic element is made from a sheet metal having a general T-shape, each bulged portion being obtained by curving one end of the head of this T, and in which the leg of the T is folded partially around the arm in order to be fastened thereto.

The invention also relates to a fork as defined above, comprising a spherical cap-shaped contact in the area of the extension to make the extension bear on a point of the support, and a contact in the shape of a cylinder portion in the area of each arm to make the arms bear linearly on the element.

The invention also relates to a device for retaining an injector holder on a heat engine cylinder head, comprising a fork as defined above.

The invention will now be described in more detail, referring to the annexed figures.

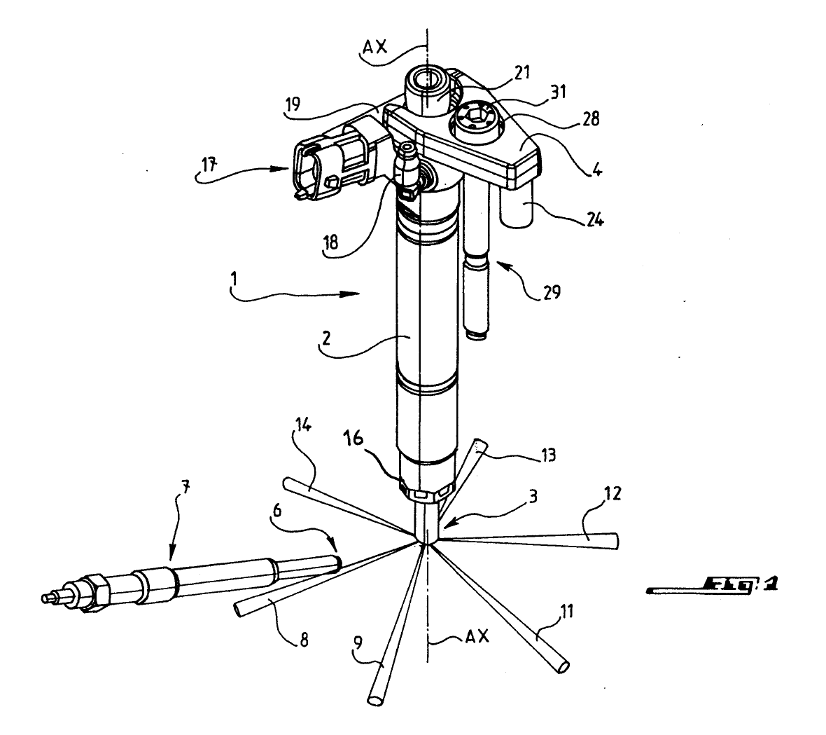

FIG. 1 is a perspective overview of an injector holder retained by a fork according to the invention;

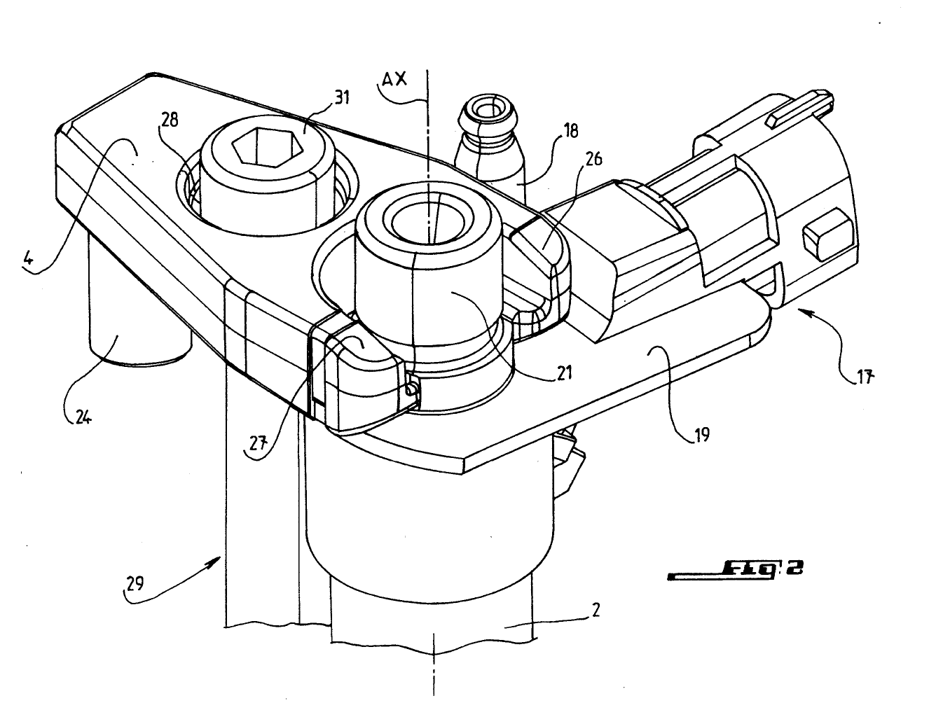

FIG. 2 is a perspective view of the fork according to the invention and an upper part of the injector holder that it retains;

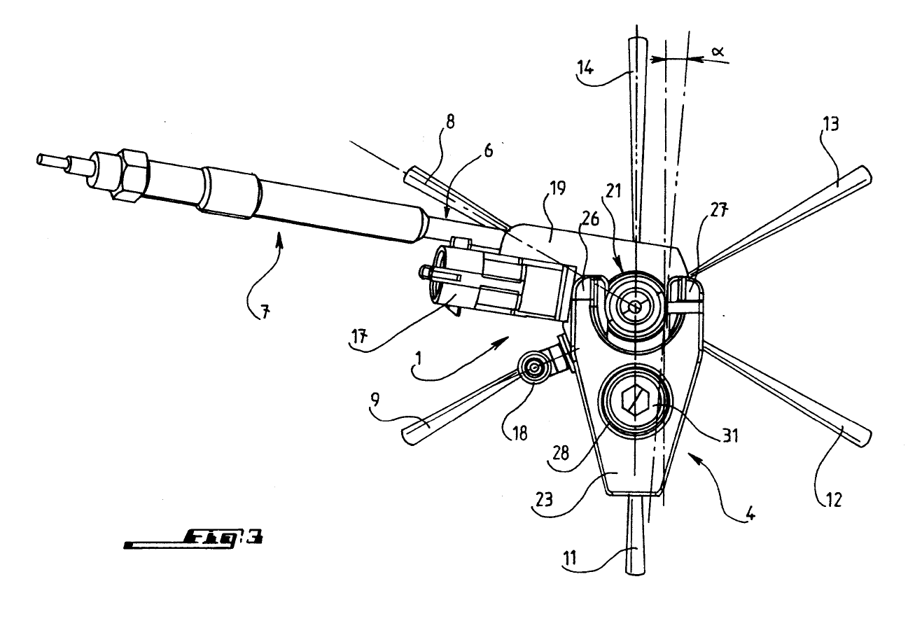

FIG. 3 is a top view of a fork according to the invention and the injector holder that it retains;

FIG. 4 is a sectional view of the fork according to the invention with its attachment screw;

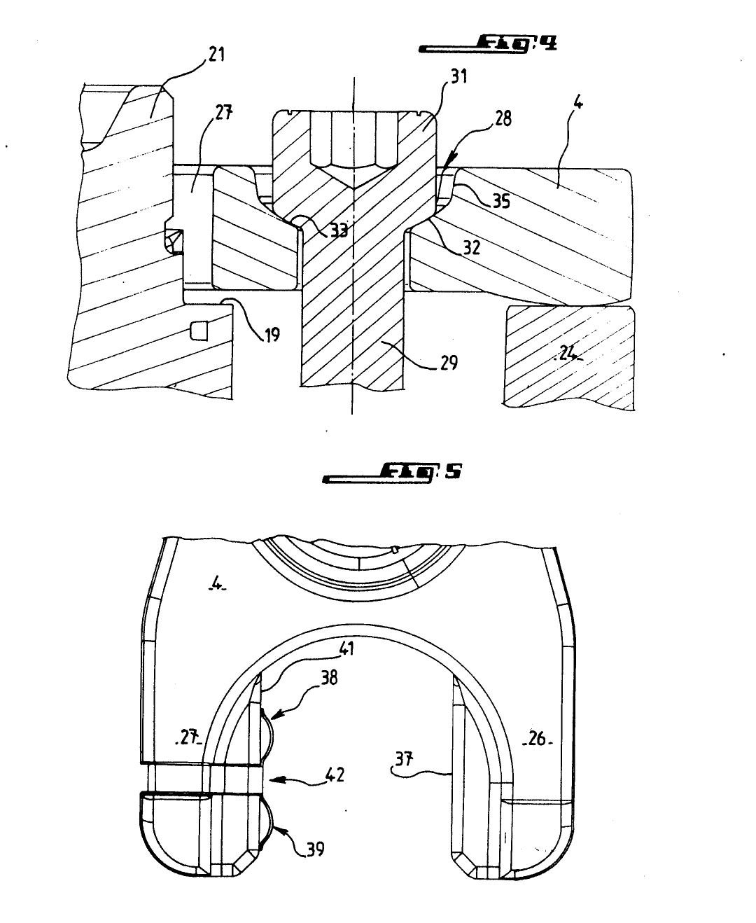

FIG. 5 is a perspective view of the arms of the fork according to the invention;

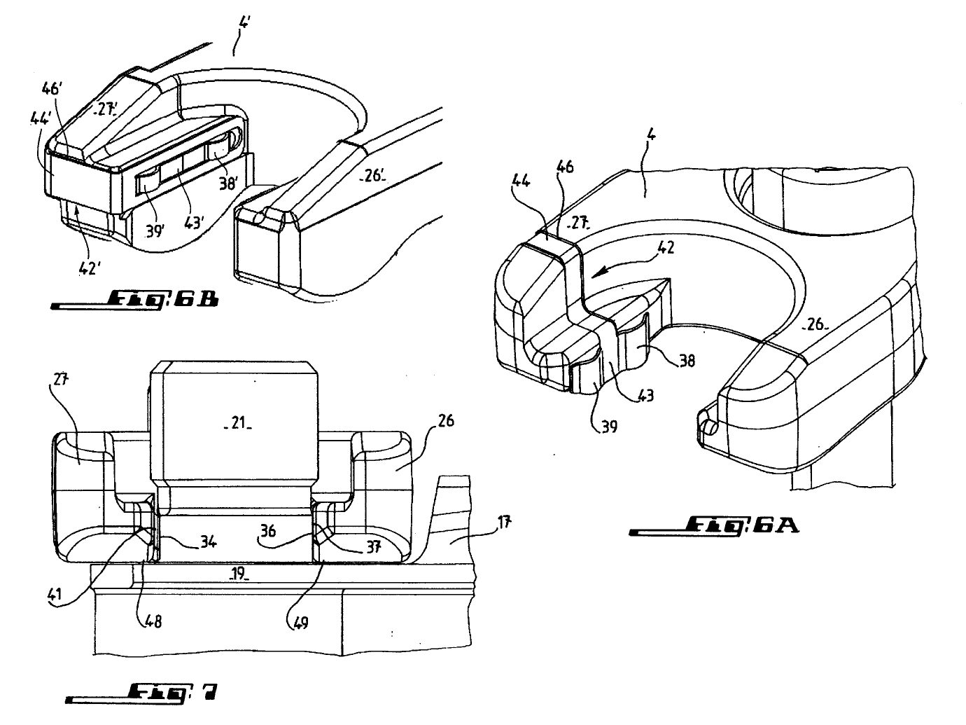

FIG. 6A is a top view of the arms of the fork according to an embodiment of the invention, the elastic element being generally T-shaped;

FIG. 6B is a top view of the arms of the fork according to an another embodiment of the invention, the elastic element being generally U-shaped;

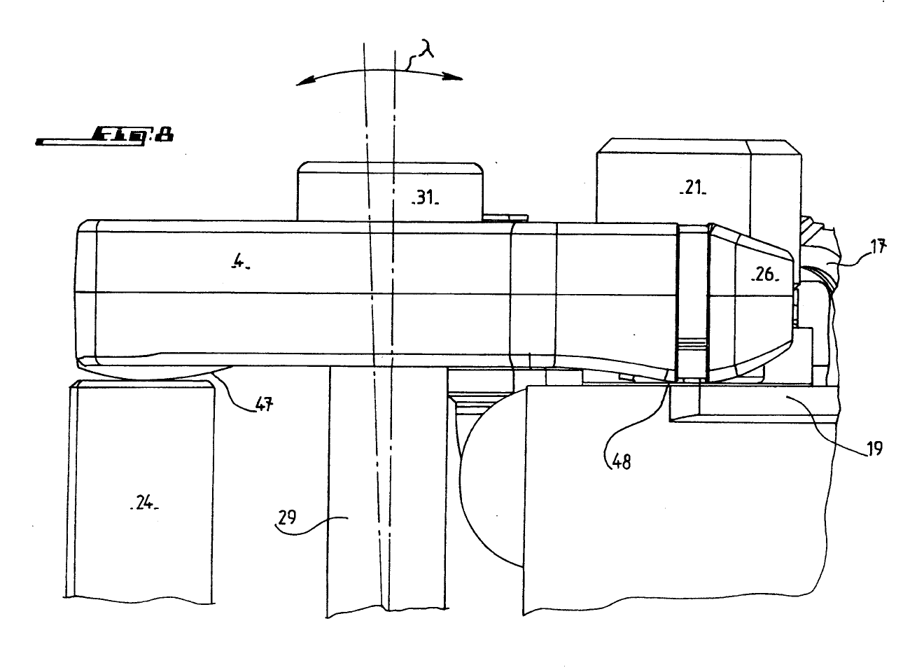

FIG. 7 is a front view of the fork according to the invention and an upper part of the injector holder that it retains;

FIG. 8 is a side view of the fork according to the invention and an upper part of the injector holder that it retains.

In FIG. 1, an injector holder 1 shown in perspective comprises a generally cylindrical main body 2 oriented along a vertical axis AX. This main body 2 comprises a lower end 3 for fuel injection, and an upper part on which a fork 4 bears in order to hold it in position in a cylinder head that is not shown.

The lower end emerges into a combustion chamber, not shown, into which an end 6 of a spark plug 7 also emerges in order to produce a spark so as to initiate combustion.

The lower end 3 injects the fuel, in the case shown here, in the form of six distinct equidistant streams referenced 8, 9, 11, 12, 13, 14 evenly distributed around the axis AX, separated from one another by a sixty-degree angle.

In the example in the figures, and in particular in FIG. 2, this injector holder 1 additionally comprises an electrical connector 17 and a fuel return nozzle 18 in its upper part. It also comprises an upper bearing surface 19 extending along a plane normal to the axis AX with a high-pressure injection head 21 located in a central area of this upper face.

As seen in FIG. 3, the injector occupies an ideal angular position with respect to its axis of rotation AX, so that the stream referenced 8 is tangent to the end 6 of the spark plug 7, which corresponds to an ideal placement in terms of combustion conditions.

The fork 4 exerts a force along the axis AX on the upper support surface 19 of the injector holder in order to hold it in position in the cylinder head by holding a stop shoulder 16 of a lower part of the main body 2 so that it bears on a corresponding seat—not shown—of the cylinder head.

This fork 4, which is shown more clearly in the top view in FIG. 3, comprises an extension 23 bearing on a stud 24 that is part of the cylinder head or added thereto. It also comprises two arms 26 and 27 extending parallel to one another, that bear on the support surface 19 and extend around the head 21.

A central opening 28 located between the extension 23 and the arms 26 and 27 is provided in the fork for accepting a clamping element, in this case a clamp screw 29, which is screwed into the cylinder head, with the head 31 of this clamp screw bearing on the fork. It is also possible to replace the screw 29, e.g., with a bolt.

As shown in FIG. 4, the opening 28 defines an inner surface generally shaped like a funnel, forming a seat on which the screw head 31 bears. Tightening the screw 29 thus spontaneously causes the fork 4 to center on the screw head 31.

More particularly, the opening 28 comprises a central bore going through to a lower face of the fork through which the screw 29 shank passes, this bore widening into a spherical cap 32 shape on which a complementary lower surface 33 of the head of the screw 29 bears.

This spherical cap 32 that forms a seat for the screw head 31 widens further into a conical-shaped surface 35 to meet a top surface of the fork 4.

Due to this seat 32 in the opening 28, the fork 4 necessarily becomes centered with respect to the position of the screw 29 head 31 while this screw is being tightened.

This ensures that the center of the fork 4 is precisely positioned so that there is no lateral displacement when it is mounted, which would result in a rotation of the fork 4, producing a corresponding displacement in the angular position of the injector holder 1 on the axis AX.

Moreover, the arms 26 and 27 of the fork that extend parallel to one another around the head 21 of the injector holder are designed to precisely secure the angular position of the injector with respect to the fork 4.

In addition, the head 21 comprises two flat areas referenced 34 and 36 in FIG. 7, one of which bears on an inner face 37 of the arm 26.

According to the invention, the angular positioning of the injector holder with respect to the fork is improved by using elastic means seen in FIGS. 5 and 6, ensuring that the flat area 36 is held tightly against the inner face 37 of the arm 26.

These elastic means form two elastic bearings 38 and 39 located on the inner face 41 of the arm 27, spaced apart from one another along this arm.

According to one embodiment, as can be seen in FIGS. 5 and 6A, these elastic means are made from an elastic sheet metal 42 with an outline in the general shape of a T. The two ends of the head 43 of the T are curved in order to bulge and form elastic bearings, with the head of the T extending generally parallel to the arm 26.

The leg 44 of the T is also curved in such a way as to go at least partially around the arm 27 in order to form a fastener to this arm. In addition, the arm 27 comprises a channel 46 into which this leg 44 is fitted in order to position the elastic element 42 longitudinally with respect to the arm 27.

Because of the elastic contacts 38 and 39, the flat area 36 of the head 21 is kept pressed against the inner face 37 of the arm 26, which makes it possible to eliminate the influence of the angular play produced by the functional play corresponding to the difference between the distance separating the inner faces 41 and 37 and the distance separating the flat areas 34 and 36.

In this way, the use of the elastic bearings 38 and 39 makes it possible to counteract the angular play between the head 21 of the injector holder and the fork 4, with this play being shown as α in FIG. 3.

The reduction of angular play in positioning is also reduced by the use of the centering seat 32 described above, which prevents a lateral displacement of the fork that can result in an additional angular defect.

Another embodiment is shown in FIG. 6B, the elements having the same references as in the preceding embodiment, with the addition of the prime sign. In this other embodiment, the elastic element 42′ is generally U-shaped, extending around an arm 27′ in such a way that the forces exerted thereupon are balanced, not dissymmetric as in the case of a T-shaped element in FIG. 6A. In this case, a longitudinal channel 46′ is provided to accommodate the body of the elastic element, with only the elastic bearings 38′ and 39′ protruding. This embodiment enables a simplified assembly.

In addition to these means, the fork is provided with bearing contacts, ensuring that it is isostatically secured on the injector holder and on the cylinder head, which further reduces gaps in positioning the fork that can result in an angular displacement of the injector holder.

To this end, the extension of the fork is provided with a contact 47 on its lower face that forms a spherical surface, as seen in FIG. 8, which defines a bearing point on the upper flat surface of the pin 24. Similarly, the arm 26 and the arm 27 are provided with contacts 48 and 49 that have coaxial cylindrical-portion surfaces defining a bearing line for these arms on the upper surface 19.

In this way, the point-bearing contact 47 eliminates a first degree of freedom of vertical movement of the fork; the line contact provided by the contacts 48 and 49 eliminates two degrees of freedom of rotation on two axes perpendicular to one another and perpendicular to the axis AX.

The other three degrees of freedom that remain include the two possible translational displacements of the fork in a plane normal to the axis AX, and the rotation of the fork on the axis AX.

The two possible translational displacements are eliminated by the ball-joint connection formed by the seat 34 and the head 31 of the screw 29. For its part, rotation of the fork on the axis AX in a plane normal to this axis is eliminated by engaging the arms 26 and 27 on the head 21 of the injector holder.

It remains to be noted that the fork according to the invention does not induce an angular positioning defect for the injector holder if there is an angular difference between the clamp screw 29 and the axis AX. This angular defect is referenced X in FIG. 8, and it corresponds to the angle between the axis AX and the axis of the screw 31, in a plane containing the axis AX and the axis of the screw 31.

The fork according to the invention thus makes it possible to precisely position the reference jet 8 with respect to the head 6 of the spark plug 7, e.g., so as to place the head 6 and the reference jet 8 in the same plane going through the axis AX.

This positioning is achieved simply by mounting the fork and tightening the screw 29, i.e., without having to make any specific adjustment.

The device according to the invention is particularly advantageous in that it enables an element to be secured translationally and rotationally at the same time with great precision in its positioning.

1. Fork for retaining an element on a support, comprising an extension intended to bear on the support and provided with a central opening intended to accept an element for clamping to the support, and two arms intended to bear on the element by extending around a head of this element, and comprising at least one flat area to secure this element rotationally, wherein the fork has an elastic element provided on one of its arms, which defines two elastic bearings interposed between an inner face of this arm and the head of the element so as to keep a flat area of this head pressed against an inner face of the opposite arm.

2. Fork according to claim 1, in which the central opening comprises a seat with an axisymmetric shape, ensuring that the fork is centered with respect to a head of the clamping element when this clamp screw is tightened.

3. Fork according to claim 1, in which the element for clamping to the support is a screw.

4. Fork according to claim 2, in which the seat has a spherical cap shape so as to define a ball-joint-type connection with the head of the clamping element.

5. Fork according to claim 1, in which the elastic element comprises two elastic bearings spaced apart from one another along the inner face of the arm so as to bear on a flat area of the head of the element.

6. Fork according to claim 5, in which the elastic element comprises a metal plate, and in which the elastic bearing points are bulged portions of this metal plate.

7. Fork according to claim 6, in which the elastic element is made from a sheet metal having a general T-shape, each bulged portion being obtained by curving one end of the head of this T, and in which the leg of the T is folded partially around the arm in order to be fastened thereto.

8. Fork according to claim 1, comprising a spherical cap-shaped contact in the area of the extension to make the extension bear on a point of the support, and a contact in the shape of a cylinder portion in the area of each arm to make the arms bear linearly on the element.

9. Device for retaining an injector holder on a heat engine cylinder head, comprising a fork according to claim 1.

10. Fork according to claim 2, in which the element for clamping to the support is a screw.

11. Fork according to claim 3, in which the seat has a spherical cap shape so as to define a ball-joint-type connection with the head of the clamping element.

12. Fork according to claim 10, in which the seat has a spherical cap shape so as to define a ball-joint-type connection with the head of the clamping element.

13. Fork according to claim 2, in which the elastic element comprises two elastic bearings spaced apart from one another along the inner face of the arm so as to bear on a flat area of the head of the element.

14. Fork according to claim 13, in which the elastic element comprises a metal plate, and in which the elastic bearing points are bulged portions of this metal plate.

15. Fork according to claim 3, in which the elastic element comprises two elastic bearings spaced apart from one another along the inner face of the arm so as to bear on a flat area of the head of the element.

16. Fork according to claim 15, in which the elastic element comprises a metal plate, and in which the elastic bearing points are bulged portions of this metal plate.

17. Fork according to claim 4, in which the elastic element comprises two elastic bearings spaced apart from one another along the inner face of the arm so as to bear on a flat area of the head of the element.

18. Fork according to claim 17, in which the elastic element comprises a metal plate, and in which the elastic bearing points are bulged portions of this metal plate.

19. Fork according to claim 10, in which the elastic element comprises two elastic bearings spaced apart from one another along the inner face of the arm so as to bear on a flat area of the head of the element.

20. Fork according to claim 19, in which the elastic element comprises a metal plate, and in which the elastic bearing points are bulged portions of this metal plate.
